(19) United States
(12) Patent Application Publication
(10) Pub. No.: US 2008/0069620 A1
(43) Pub. Date: Mar. 20, 2008

(54) Hand-operated Printer and Printer Dock Configured to Facilitate Auxiliary Printing

(76) Inventors: Miles Edward Anderson, Georgetown, KY (US); Edmund Hulin James, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/531,830

(22) Filed: Sep. 14, 2006

(51) Int. Cl. B41J 3/36

(52) U.S. Cl. 400/88

(57) ABSTRACT

An imaging apparatus includes a hand-operated printer and a printer dock. The hand-operated printer has a body and a printing mechanism coupled to the body. The printer dock has a cradle configured for removably mounting the hand-operated printer, and has a recessed region formed on the cradle to define a print medium slot that permits printing access to the printing mechanism when the hand-operated printer is mounted to the printer dock.

### FIELD OF THE INVENTION

The present invention relates to an imaging apparatus, and, more particularly, to a hand-operated printer and printer dock configured to facilitate auxiliary printing.

A typical desktop ink jet printer is a stationary apparatus that includes a reciprocating printhead carrier that carries a printhead in a main scan direction, and includes a drive roller assembly that advances a print medium in a sub-scan direction relative to the printhead. Such ink jet printers typically require user interaction in some form. For example, one such desktop ink jet printer may utilize a host computer in making selections, adjusting parameters, etc. Such an ink jet printer also may include one or more input buttons,

In contrast to desktop printers, a hand-held printer, also sometimes referred to as a hand-operated printer, is moved in its entirety relative to the print medium, such as paper, and does not include a drive mechanism for positioning a printhead relative to the print medium. In other words, the hand-held printer is manually moved over the print medium by way of a motive force exerted via a user's hand. Such a hand-held printer is typically referred to as a single axis printer. An optical encoder typically is used to provide position feedback of relative motion between the hand-held printer and the print medium,

### SUMMARY OF THE INVENTION

The present invention provides a hand-operated printer and printer dock configured to facilitate auxiliary printing.

The invention, in one form thereof, is directed to an imaging apparats The imaging apparatus includes a hand-operated printer and a printer dock. The hand-operated printer has a body and a printing mechanism coupled to the body. The printer dock has a cradle configured for removably mounting the hand-operated printer, and has a recessed region formed on the cradle to define a print medium slot that permits printing access to the printing mechanism when the hand-operated printer is mounted to the printer dock.

The invention, in another form thereof, is directed to a printer dock, including a cradle. A recessed region is formed on the cradle to define a print medium slot that permits access to a printing mechanism when a hand-operated printer is mounted to the printer dock.

The invention in another form thereof, is directed to a method for auxiliary printing with a hand-operated printer The method includes: a user mounting the hand-operated printer to a printer dock for printing in an auxiliary print mode; retrieving an image from a device communicatively coupled to the hand-operated printer; inserting a print medium into a print medium slot formed in the printer dock; manually moving the print medium along a scan path through the print medium slot; automatically sensing a distance of movement of the print medium in the print medium slot along the scan path; and commencing printing the image on the print medium after the print medium has moved a predetermined distance through the print medium slot to reach a designated print position on the print medium.

### BRIEF DESCRIPTION OF THE DRAWINGS

The above-mentioned and other features and advantages of this invention and the manner of attaining them, will become more apparent and the invention will be better understood by reference to the following description of an embodiment of the invention taken in conjuction with the accompanying drawings, wherein:

FIG. 1 is a side perspective view of a hand-operated printer and a printer dock, with the hand-operated printer mounted in a maintenance mounting position,

FIG. 2 is a front perspective view of the hand-operated printer and printer dock of FIG. 1, with the hand-operated printer separated from the printer dock.

FIG. 3 is a bottom view of the hand-operated printer of FIG. 1

FIG. 4 is a perspective view of the hand-operated printer of FIG. 1 during a primary printing operation.

FIG. 5 is a general diagrammatic representation of the hand-operated printer of FIG. 1.

FIG. 6 is an exploded view of the printer dock of FIG. 1.

FIG. 7 is a side perspective view of a hand-operated printer and a printer dock, with the hand-operated printer mounted in an auxiliary print mode mounting position

FIG. 8 is a general flowchart of a method of auxiliary printing with the hand-operated printer of FIG. 1.

Corresponding reference characters indicate corresponding parts throughout the several views. The exemplifications set out herein illustrate one embodiment of the invention, in one form, and such exemplifications are not to be construed as limiting the scope of the invention in any manner.

### DESCRIPTION OF THE PREFERRED EMBODIMENT

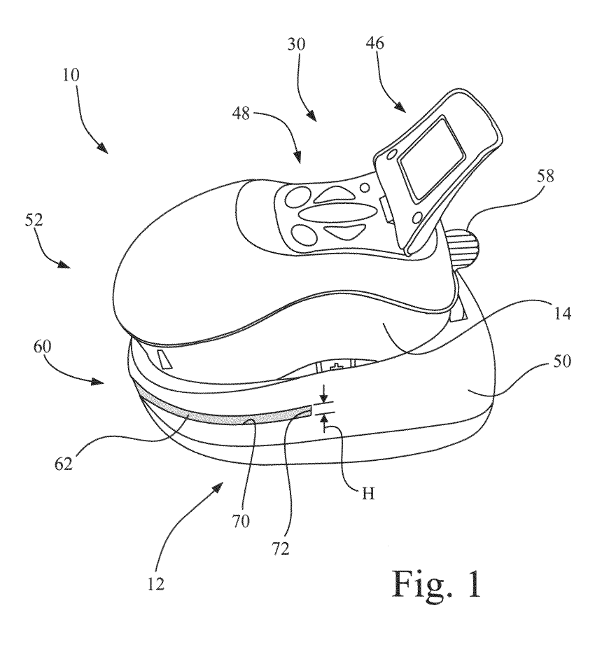

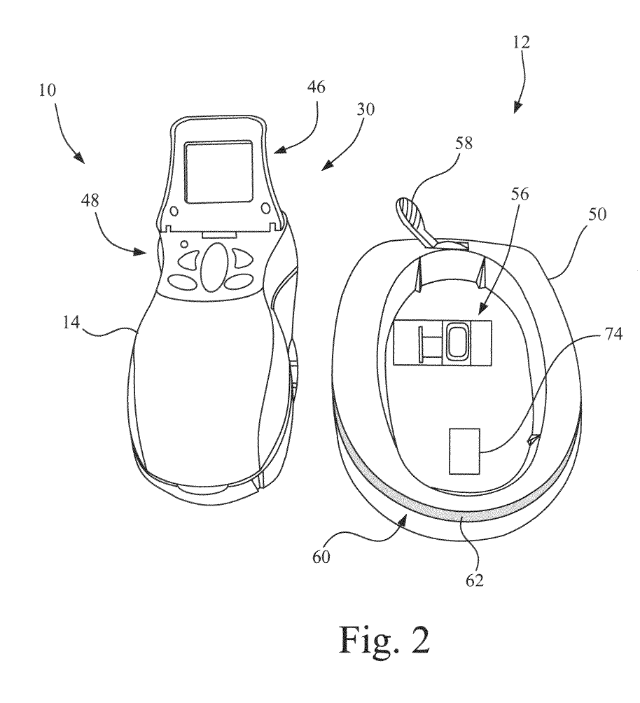

Referring now to the drawings and particularly to FIG. 1, there is shown a perspective view of a hand-operated printer 10 stationed in a printer dock 12. FIG. 2 is a perspective view of a hand-operated printer 10 separated from printer dock 12. Hand-operated printer 10 and printer dock 12 are configured in accordance with the present invention to facilitate an auxiliary print mode, e.g., the printing of envelopes, when hand-operated printer 10 is mounted to printer dock 12, in addition to a primary print mode facilitated by hand-operated printer 10 when hand-operated printer 10 is separated from printer dock 12.

As shown in FIGS. 1-3, hand-operated printer 10 includes a body 14 and a printing mechanism 16. Body 14 is configured with a smooth bottom surface 14-1 that contacts a print medium 18, such as for example, a sheet of paper, transparency, card stock, fabric, hard surface, soft surface, etc.

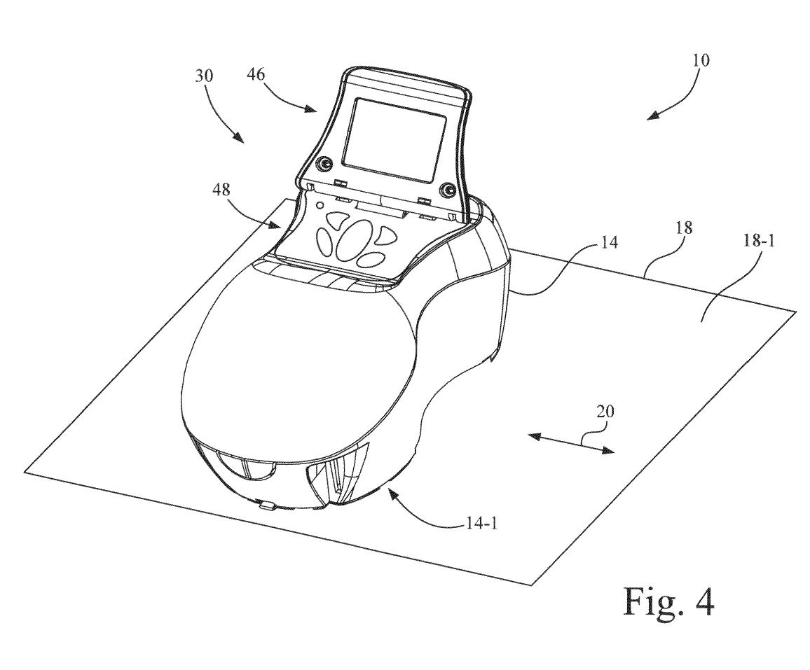

During a primary printing operation, as illustrated in FIG. 4, a user provides the motive force to provide movement of hand-operated printer 10 relative to print medium 18. Movement of the hand-operated printer 10 relative to print medium 18 along a scan path 20, e.g., a scan axis, results in relative movement of printing mechanism 16 with respect to a printing surface 18-1 of print medium 18 along scan path 20. The term “scan path” is intended to include both linear and non-linear movement of hand-operated printer 10. The smooth surface 14-1 of body 14 contacts print medium 18 to provide the desired spacing between printing mechanism 16 and printing surface 18-1 of print medium 18.

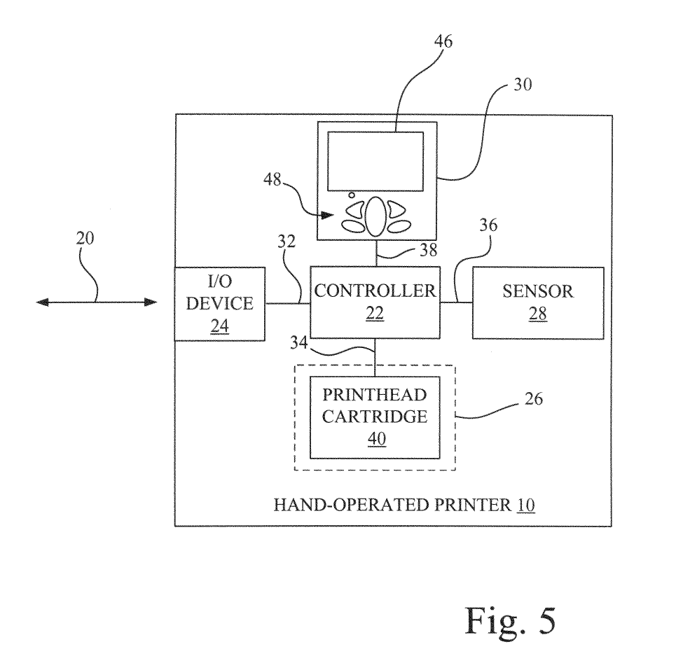

FIG. 5 is a general diagrammatic representation of hand-operated printer 10. Hand-operated printer 10 may be, for example, a hand-operated ink jet printer, and may include a controller 22, an input/output (I/O) device 24, a cartridge receptacle 26, a sensor 28, and an operator panel 30. Each of controller 22, I/O device 24, cartridge receptacle 26, sensor 28, and operator panel 30 are mounted to body 14.

Controller 22 includes a processor unit and associated memory, and may be formed as one or more Application Specific Integrated Circuits (ASIC). Controller 22 executes program instructions to perform data processing and formatting, facilitate printing control, and/or facilitate device interaction with respect to one or more of a plurality of devices in communication with controller 22. Controller 22 is communicatively coupled to I/O device 24 via communications link 32. Controller 22 is communicatively coupled to cartridge receptacle 26 via a communications link 34. Controller 22 is communicatively coupled to sensor 28 via a communications link 36. Controller 22 is communicatively coupled to operator panel 30 via communications link 38.

As used herein, the term “communications link” generally refers to structure that facilitates electronic communication between components, and may operate using wired or wireless technology.

I/O device 24 may be configured in a variety of ways, depending on the source and/or destination of the communicated content. For example, I/O device 24 may be a wired, e.g., USB, or wireless, e.g., IEEE 802XX, communication device that provides a communications link to a source of image content, such as for example, a memory card reader and associated memory card. Alternatively, I/O device 24 may be a host computer, or some other intelligent device, such as a digital camera, that may supply image data for printing by hand-operated printer 10.

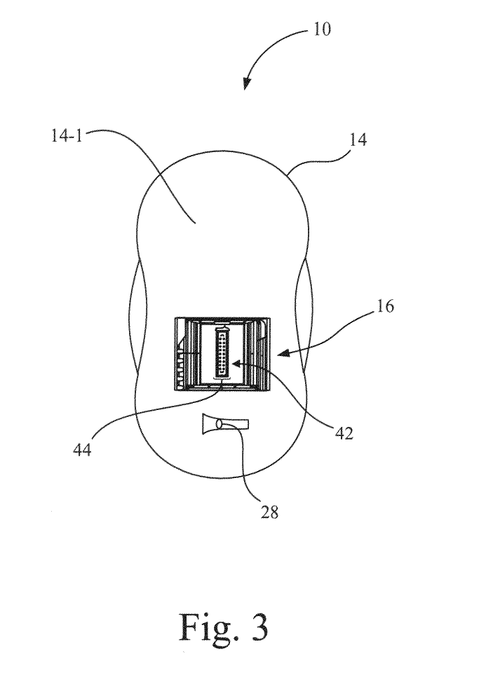

Cartridge receptacle 26, for example, may be formed in body 14 and configured for receiving and mounting at least one printhead cartridge 40. Cartridge receptacle 26 holds printhead cartridge 40 in a fixed position relative to hand-operated printer 10. Printhead cartridge 40 is communicatively coupled to controller 22 via communications link 34. As shown in the example of FIG. 3, printhead cartridge 40 includes an ink jet printhead 42 including an array of ink jetting nozzles 44. Printhead cartridge 40 further includes a supply of ink

Movement of the hand-operated printer 10 relative to print medium 18 along a scan path 20 results in relative movement of printhead cartridge 40 and ink jet printhead 42 with respect to printing surface 8-1 of print medium 18 along scan path 20. The smooth surface 14-1 of body 14 contacts print medium 8 to provide the desired spacing between printhead 42 and the printing surface 18-1 of print medium 18.

Sensor 28 may be, for example, an optical encoder positioned on the underside of hand-operated printer 10, as shown in FIG. 3, and may be configured to sense movement in one or more directions so as to determine a position relative to print medium 18, e.g., a print position. Sensor 28 detects movement by sensing small changes in the surface features, e.g., roughness, of print medium 18. Sensor 28 may be, for example, a unitary optical sensor including a light source and a detector, each positioned to establish an angle of incidence, e.g., angle of reflection, with respect to the printing surface 18-1 of print medium 18. Sensor 28 may include one or more such unitary optical sensors. Each light source may include, for example, a light emitting diode (LED) emitting a predetermined color of light, and each detector may be, for example, a phototransistor whose voltage, or current, output varies as a function of the intensity of the reflected light that it receives. The output of each phototransistor is processed by controller 22, individually or collectively,

As shown, for example, in FIGS. 1 and 2, operator panel 30 includes a display screen 46, coupled by hinges to body 14, and a plurality of control buttons 48. Display screen 46 and control buttons 48 are communicatively coupled to controller 22 via communications link 38. Display screen 46 may include, for example, a liquid crystal display (LCD) screen having, for example, a resolution (height×width) of 81×101 pixels. Control buttons 48 may be configured to control such functions as, for example, power-ON/OFF, print, menu display, select, cancel, etc. Of course, the number of buttons used may deviate from that illustrated in the exemplary embodiment of hand-operated printer 10 shown in FIGS. 1-7, depending on the actual configuration of the hand-operated printer and the applications for which the hand-operated printer may be used.

If, for example, a user desires to print an image in the primary print mode, such as an image displayed on display screen 46, then hand-operated printer 10 is turned ON, and hand-operated printer 10 is moved relative to print medium 18 along scan path 20. Controller 22 controls printhead 42 to print the image on print medium 18 corresponding to the image selection made by the user. A distance of movement of hand-operated printer 10 in at least one direction is automatically sensed by sensor 28, and printing will commence to form an image on print medium 18 after hand-operated printer 10 has moved a predetermined distance to reach a designated print position.

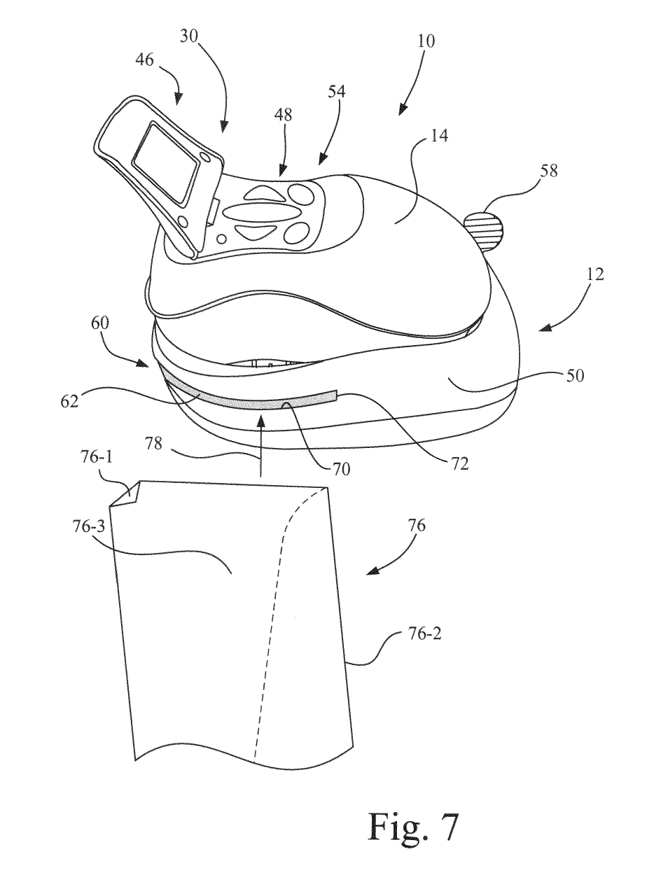

Referring to FIGS. 1, 2, and 7, printer dock 12 has a cradle 50 configured for removably mounting hand-operated printer 10 in either of two mounting positions: a maintenance mounting position 52 illustrated in FIG. 1, and an auxiliary print mode mounting position 54 illustrated in FIG. 7. In the present embodiment, body 14 of hand-operated printer 10 is rotated about 180 degrees with respect to printer dock 12 in moving hand-operated printer 10 from maintenance mounting position 52 to auxiliary print mode mounting position 54, and vice-versa. Thus, for example, the footprint of hand-operated printer 10, illustrated in 3, is substantially symmetrical from top to bottom to accommodate a 180 degree rotation of body 14 of hand-operated printer 10 with respect to printer dock 12 and still be received into cradle 50 of printer dock 12.

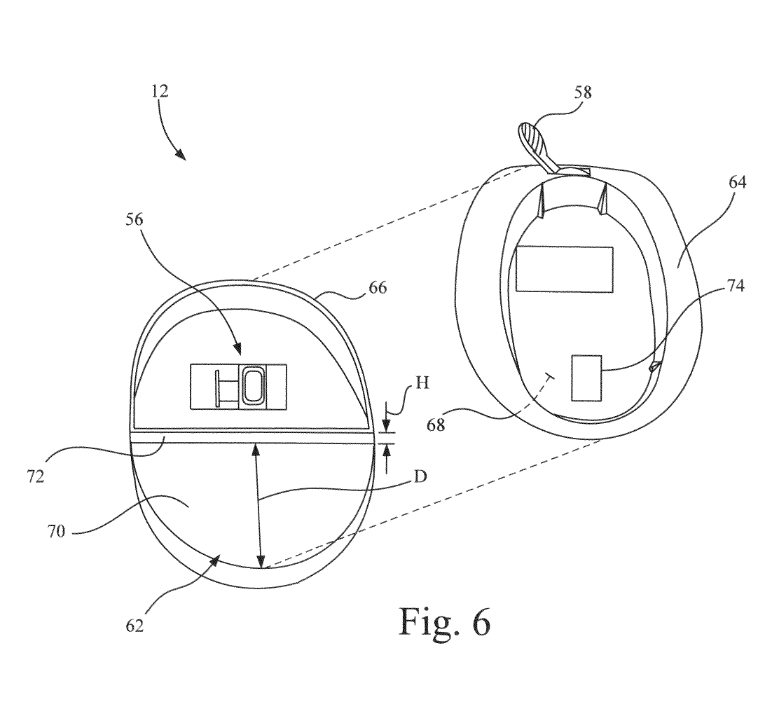

As shown in FIGS. 2 and 6, printer dock 12 includes a maintenance station 56 for performing printhead maintenance. For example, when hand-operated printer 10 is mounted to printer dock 12 in the maintenance mounting position 52 illustrated in FIG. 1, then ink jet printhead 42 (see FIG. 3) is positioned adjacent printhead maintenance station 56 to facilitate a printhead maintenance operation for ink jet printhead 42. A lever 58 is mechanically coupled to maintenance station 56. With hand-operated printer 10 mounted to printer dock 12 in the maintenance mounting position 52, a manual actuation of lever 58 by a user causes maintenance station 56 to perform a wiping and capping operation on ink jet printhead 42. In addition, lever 58 may be used to release hand-operated printer 10 from its mounting position on printer dock 12.

As illustrated in FIGS. 1, 2, 6 and 7, printer dock 12 has a recessed region 60 formed on cradle 50 to define a print medium slot 62 that permits printing access to printing mechanism 16, and sensor 28, when hand-operated printer 10 is mounted to printer dock 12 in auxiliary print mode mounting position 54 illustrated in FIG. 7. As shown in FIGS. 1, 2 and 6, printer dock 12 includes a cover portion 64 that is attached to a base portion 66. Cover portion 64 defines an upper guide surface 68 of print medium slot 62, and base portion 66 defines a lower guide surface 70 and an end guide wall 72. Lower guide surface 70 may be, for example, a substantially planar continuous surface for providing support to a backside of a print medium. Alternatively, surface 14-1 of hand-operated printer 10 may serve, in whole or in part, as upper guide surface 68.

End guide wall 72 defines a depth D and a height H of print medium slot 62, with end guide wall 72 extending perpendicularly between lower guide surface 70 and upper guide surface 68. End guide wall 72 may be located at a fixed position with respect to base portion 66, so as to provide a fixed depth D. Alternatively, end guide wall 72 may be slidably coupled to base portion 66 to provide a sliding backstop for adjusting depth D, so as to permit a user to select the desired maximum depth D that a print medium, e.g., an envelope, may be inserted into print medium slot 62 of printer dock 12.

Cover portion 64 includes an access opening 74 that exposes printing mechanism 16, e.g., ink jet printhead 42, and sensor 28, of hand-operated printer 10 to print medium slot 62 of printer dock 12 when hand-operated printer 10 is mounted to printer dock 12 in auxiliary print mode mounting position 54, with both ink jet printhead 42 and sensor 28 facing lower guide surface 70 through access opening 74.

Thus, hand-operated printer 10 and printer dock 12 are configured such that when hand-operated printer 10 is mounted with respect to printer dock 12 at auxiliary print mode mounting position 54 (see FIG. 7), printing mechanism 16, e.g., including ink jet printhead 42, is positioned adjacent to, and facing, print medium slot 62 to facilitate printing of a print medium manually conveyed through print medium slot 62 past printing mechanism 16. Conversely, hand-operated printer 10 and printer dock 12 are configured such that when hand-operated printer 10 is mounted with respect to printer dock 12 at maintenance mounting position 52 (see FIG. 1), printing mechanism 16, e.g., including ink jet printhead 42, is positioned not adjacent to print medium slot 62, but rather, is positioned adjacent to and facing maintenance station 56.

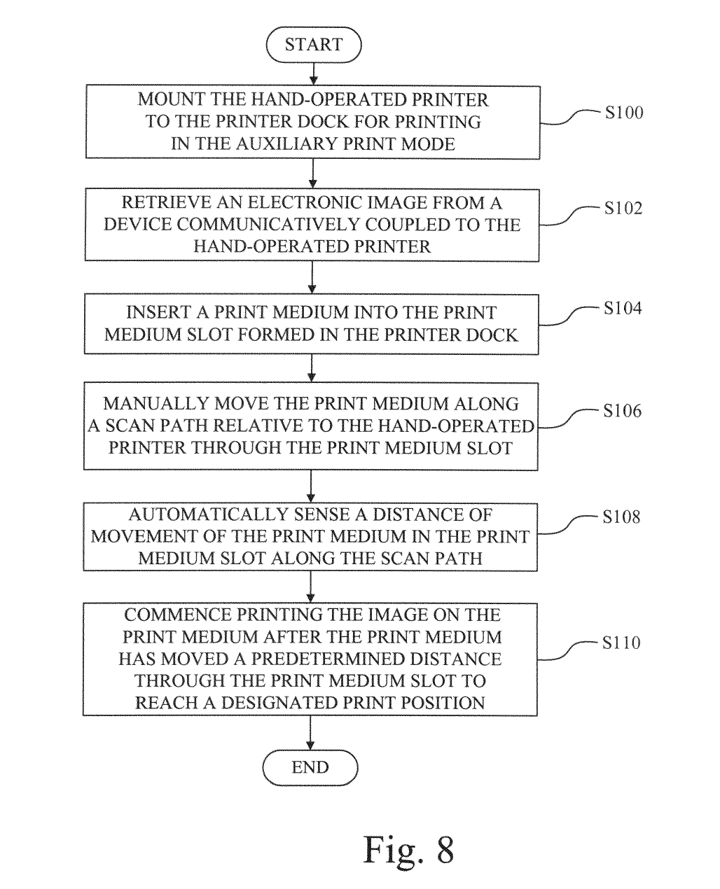

FIG. 8 is a general flowchart of a method of auxiliary printing with hand-operated printer 10, described with reference to FIGS. 1-7.

At step S100, a user mounts hand-operated printer 10 to printer dock 12 for printing in the auxiliary print mode. For example, if a user desires to print an image in the auxiliary print mode, then hand-operated printer 10 is mounted to printer dock 12 at auxiliary print mode mounting position 54, and hand-operated printer 10 is turned ON. Hand-operated printer 10 may automatically determine that hand-operated printer 10 is mounted to printer dock 12 at auxiliary print mode mounting position 54 via sensor 28, and automatically select the auxiliary print mode. Alternatively, the user may manipulate control buttons 48 to place hand-operated printer 10 in the auxiliary print mode,

At step S102, an electronic image is retrieved from a device communicatively coupled to hand-operated printer 10 For example, the user may manipulate control buttons 48 to retrieve a digital image, such as an envelope indicia, from a device communicatively coupled to I/O device 24, or from memory associated with controller 22. The envelope indicia may be, for example, one or more of a return address, a greeting, a bar code, and a postage symbol. The image, or a portion thereof, may be displayed on display screen 46. The user may then manipulate control buttons 48 to signal controller 22 that the user is ready to begin printing in the auxiliary print mode.

At step S104, a print medium is inserted into print medium slot 62 formed in printer dock 12. For example, a print medium 76, such as an envelope, is manually inserted into print medium slot 62.

At step S106, print medium 76 is manually moved along a scan path 78 relative to hand-operated printer 10 through print medium slot 62, with a backside 76-1 of print medium 76 resting on lower guide surface 70, and with an edge 76-2 of print medium 76 pushed up against end guide wall 72.

At step S108, the method automatically senses a distance of movement of print medium 76 in print medium slot 62 along scan path 78. For example, a distance of movement of print medium 76 along scan path 78 may be automatically sensed by sensor 28 of hand-operated printer 10. Controller 22 executes program instructions to read sensor 28.

At step S110, the method commences printing the image on print medium 76 after print medium 76 has moved a predetermined distance through print medium slot 62 to reach a designated print position on print medium 76. For example, controller 22 executes program instructions to control printhead 42 to print an image on printing surface 76-3 of print medium 76 corresponding to the image selection made by the user, and printing will commence forming the envelope indicia on print medium 76 after print medium 76 has moved a predetermined distance to reach the designated print position called for by the print data representing the envelope indicia.

During printing in the auxiliary print mode, ink jet printhead 42 ejects ink from ink jetting nozzles 44 in a direction substantially perpendicular to lower guide surface 70, and in turn, substantially perpendicular to a printing surface 76-3 of print medium 76. Similarly, scan path 78 is substantially parallel to lower guide surface 70, and is substantially perpendicular to the ink ejection direction.

While this invention has been described with respect to an embodiment of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An imaging apparatus comprising:
a hand-operated printer having a body and a printing mechanism coupled to said body; and
a printer dock having a cradle configured for removably mounting said hand-operated printer, and having a recessed region formed on said cradle to define a print medium slot that permits printing access to said printing mechanism when said hand-operated printer is mounted to said printer dock,

2. The imaging apparatus of claim 1, wherein said hand-operated printer and said printer dock are configured to define a first mounting position of said hand-operated printer with respect to said printer dock to position said printing mechanism adjacent said print medium slot to facilitate printing of a print medium manually conveyed through said print medium slot past said printing mechanism, and to define a second mounting position of said hand-operated printer with respect to said printer dock wherein said printing mechanism is not adjacent said print medium slot.

3. The imaging apparatus of claim 2, said hand-operated printer having an ink jet printhead, and wherein when said hand-operated printer is in said first mounting position said ink jet printhead is positioned to face a lower guide surface of said print medium slot.

4. The imaging apparatus of claim 2, said hand-operated printer having an ink jet printhead and said printer dock having a printhead maintenance station, and wherein when said hand-operated printer is in said second mounting position, said ink jet printhead is positioned adjacent said printhead maintenance station to facilitate a printhead maintenance operation for said ink jet printhead,

5. The imaging apparatus of claim 2, wherein said body of said hand-operated printer is rotated about 180 degrees in moving said hand-operated printer from said first mounting position to said second mounting position.

6. The imaging apparatus of claim 1, further comprising:
a controller coupled to said printing mechanism; and
a sensor mounted to said body, and coupled to said controller, said sensor being positioned to sense motion of a print medium passing through said print medium slot.

7. The imaging apparatus of claim 6, said controller executing program instructions to read said sensor and perform a printing operation when said sensor senses a movement of said print medium in said print medium slot past said printing mechanism.

8. The imaging apparatus of claim 7, wherein said print medium is an envelope, and said printing operation forms an indicia on said envelope.

9. The imaging apparatus of claim 8, wherein said indicia is at least one of a return address, a greeting, a bar code, and a postage symbol.

10. The imaging apparatus of claim 1, said cradle including:
a cover portion that defines an upper guide surface of said print medium slot; and
a base portion that defines a lower guide surface of said print medium slot.

11. The imaging apparatus of claim 10, wherein said lower guide surface is a substantially planar continuous surface for providing support to a backside of a print medium.

12. The imaging apparatus of claim 10, wherein said based portion includes an end guide wall that defines a depth and a height of said print medium slot.

13. The imaging apparatus of claim 10, wherein said cover portion includes an access opening that exposes said printing mechanism of said hand-operated printer to said print medium slot when said hand-operated printer is mounted to said printer dock in a mounting position for printing, wherein said printing mechanism is positioned to face said lower guide surface of said print medium slot.

14. A printer dock configured for removably mounting a hand-operated printer, comprising:
a cradle; and
a recessed region formed on said cradle to define a print medium slot that permits access to a printing mechanism when said hand-operated printer is mounted to said printer dock.

15. The printer dock of claim 14, said cradle including:
a cover portion that defines an upper guide surface of said print medium slot; and
a base portion that defines a lower guide surface of said print medium slot,

16. The printer dock of claim 15, wherein said lower guide surface is a substantially planar continuous surface for providing support to a backside of a print medium.

17. The printer dock of claim 15, wherein said base portion includes an end guide wall that defines a depth and a height of said print medium slot.

18. The printer dock of claim 15, wherein said cover portion includes an access opening that exposes a printhead and a sensor of said hand-operated printer to said print medium slot when said hand-operated printer is mounted to said printer dock in a mounting position for printing.

19. The printer dock of claim 14, wherein printer dock is configured to define a first mounting position of said hand-operated printer, and a second mounting position of said hand-operated printer rotated about 180 degrees from said first mounting position.

20. A method for auxiliary printing with a hand-operated printer, comprising:
a user mounting said hand-operated printer to a printer dock for printing in an auxiliary print mode;
retrieving an image from a device communicatively coupled to said hand-operated printer;
inserting a print medium into a print medium slot formed in said printer dock;
manually moving said print medium along a scan path through said print medium slot;
automatically sensing a distance of movement of said print medium in said print medium slot along said scan path; and
commencing printing said image on said print medium after said print medium has moved a predetermined distance through said print medium slot to reach a designated print position on said print medium,
